(19) United States
(12) Patent Application Publication
(10) Pub. No.: US 2025/0367779 A1
(43) Pub. Date: Dec. 4, 2025

(54) POWER TOOL

(71) Applicant: Nanjing Chervon Industry Co., Ltd., Nanjing (CN)

(72) Inventors: Zhongquan Xu, Nanjing (CN); Bin Yang, Nanjing (CN); Jie Guo, Nanjing (CN); Tong Zhou, Nanjing (CN); Yasheng Chen, Nanjing (CN); Xiang Zhao, Nanjing (CN)

(21) Appl. No.: 19/305,370

(22) Filed: Aug. 20, 2025

Related U.S. Application Data
(63) Continuation of application No. PCT/CN2024/080318, filed on Mar. 6, 2024.

(30) Foreign Application Priority Data
Mar. 20, 2023 (CN) 202310273839.1
Feb. 28, 2024 (CN) 202410223694.9

(51) Int. Cl. B24B 23/02; B25F 5/00; B25F 5/02

(52) U.S. Cl. CPC B24B 23/028; B24B 23/022; B25F 5/001; B25F 5/02

(57) ABSTRACT

A handheld power tool includes a grip for a user to hold; an output shaft rotatable about a first axis; a mounting device for mounting a working attachment to the output shaft, where the working attachment has a mounting port that matches the output shaft; and an operating member capable of driving the output shaft to move along the direction of the first axis to lock or loosen the working attachment. The operating member could be located at least at a first position, a second position and a third position. When the operating member is located at the first position, the working attachment is locked; when the operating member moves from the first position to the second position, the output shaft moves downward along the first axis by a first preset distance. The third position is different from the first position and the second position.

### RELATED APPLICATION INFORMATION

This application is a continuation of International Application Number PCT/CN2024/080318, filed on Mar. 6, 2024, through which this application also claims the benefit under 35 U.S.C. § 119(a) of Chinese Patent Application No. CN 202310273839.1, filed on Mar. 20, 2023, and Chinese Patent Application No. CN 202410223694.9, filed on Feb. 28, 2024, which application are incorporated herein by reference in their entireties.

### BACKGROUND

An angle grinder is a multi-functional cutting tool for grinding, cutting, derusting, polishing, weld bead grinding, weld root cleaning, and the like of a metal component. The angle grinder grinds, cuts, derusts, or polishes the metal component by using a sheet working attachment, a rubber working attachment, a wire wheel, or the like that rotates at a high speed. The angle grinder has the advantages of convenient use, a high rotational speed, a high cutting speed, and rapid weld bead grinding.

For traditional angle grinding tools, the installation and removal of the working attachment require the cooperation of tools such as a shaft lock and a wrench, which is troublesome and wastes energy. To solve the preceding problems, a power tool whose working attachment can be quickly mounted and removed is launched on the market. An additional quick release structure is designed to complete the quick installation and removal of the working attachment. However, the working attachment adapted to the preceding power tool capable of quick clamping needs to be specially customized by the manufacturer and cannot be used with the most common attachments with circular mounting ports on the market, resulting in limited usage and higher costs.

Moreover, when a quick release structure that can be quickly mounted and removed is designed, an improper operation by the user may occur, causing difficulty in removing the working attachment.

### SUMMARY

The present application provides the technical solutions below. A power tool includes a grip for a user to hold; an output shaft rotatable about a first axis; a mounting device for mounting a working attachment to the output shaft, where the working attachment has a mounting port that matches the output shaft; and an operating member capable of driving the output shaft to move along the direction of the first axis to lock or loosen the working attachment.

In an example, the mounting port is circular.

In an example, the operating member has at least a first position and a second position, where when the operating member is located at the first position, the working attachment is locked; and when the operating member moves from the first position to the second position, the output shaft moves downward along the first axis by a first preset distance.

In an example, the operating member further has a third position, where when the operating member moves from the first position to the third position, the output shaft moves downward along the first axis by a second preset distance, and the second preset distance is greater than the first preset distance.

In an example, a locking member is further included, where the locking member is capable of being driven by the operating member to move to drive the output shaft to move.

In an example, the operating member is in shape fit or concave-convex fit with the locking member so that when the operating member rotates to a position to loosen the working attachment, the locking member does not rotate relative to the operating member.

In an example, a second elastic member always in a compressed state to apply an elastic force to the output shaft is further included, where when the output shaft moves downward along the first axis, the output shaft further compresses the second elastic member.

In an example, during a movable stroke of the operating member, the maximum pressure applied to the output shaft is greater than or equal to 80 N.

In an example, the mounting device includes an upper flange and a lower flange, the upper flange is closer to the operating member than the lower flange, the upper flange and the output shaft are movably connected, the lower flange and the output shaft are threadedly connected, and when the working attachment is mounted on the output shaft, the working attachment is mounted between the upper flange and the lower flange.

In an example, the operating member is rotatable about a second axis, where the second axis is basically perpendicular to the first axis, or the second axis is basically parallel to the first axis.

In an example, the lower flange includes a flange body and movable members, the movable member is provided with a mating portion mating with external threads of the output shaft, the movable member has a locked state in which the movable member is connected to the output shaft and an unlocked state in which the movable member is detached from the output shaft, the movable member switches to the locked state when the movable member abuts against the working attachment, and the movable member switches to the unlocked state when the movable member is detached from the working attachment.

In an example, the movable member is mounted on the flange body via a rotary shaft, the movable member is rotatable about the axis of the rotary shaft, and the axis of the rotary shaft is perpendicular to the first axis.

In an example, sliding grooves are obliquely disposed on the flange body, the movable member is movable along the sliding groove, and when the movable member moves in the sliding groove, the movable member is capable of being displaced along the direction of the first axis.

In an example, a locking member, locking beads, and a first elastic member are further included, where an upper end surface of the output shaft is provided with a countersunk hole, a portion of the locking member is disposed in the countersunk hole, the locking member mates with the operating member to drive the output shaft, and an outer wall of the locking member is provided with locking grooves; a sidewall of the output shaft is provided with locking holes connecting with the countersunk hole, the locking beads are movably disposed in the locking holes, and the locking beads are capable of mating with the locking grooves to lock the locking member and the output shaft as a whole; and the first elastic member is disposed in the countersunk hole, is in a compressed state, and is disposed between a lower end of the locking member and a bottom wall of the countersunk hole.

A power tool includes an output shaft rotatable about a first axis; a mounting device for mounting a working attachment to the output shaft; and an operating member capable of driving the output shaft to move along the direction of the first axis to lock or loosen the working attachment, where the operating member can be located at three positions including a first position, a second position, and a third position, where when the operating member is located at the first position, the working attachment is locked; when the operating member is located at the second position, the working attachment is capable of being mounted to the output shaft; and when the operating member is located at the third position, the working attachment is capable of being removed from the output shaft.

A power tool includes an output shaft rotatable about a first axis; a mounting device for mounting a working attachment to the output shaft; and an operating member capable of driving the output shaft to move along the direction of the first axis to lock or loosen the working attachment, where the operating member can be located at three positions, including a first position, a second position, and a third position, where when the operating member is located at the first position, the working attachment is locked; when the operating member moves from the first position to the second position, the output shaft moves downward along the first axis by a first preset distance; and when the operating member moves from the first position to the third position, the output shaft moves downward along the first axis by a second preset distance, where the second preset distance is greater than the first preset distance.

### BRIEF DESCRIPTION OF THE DRAWINGS

FIG. 1 is a structural view of a handheld power tool according to an example of the present application.

FIG. 2 is a sectional view of a handheld power tool according to an example of the present application.

FIG. 3 is a partial sectional view of a handheld power tool with an operating member at a first position according to an example of the present application.

FIG. 4 is a partial enlarged view of part A in FIG. 3.

FIG. 5 is a partial sectional view of a handheld power tool with an operating member at a second position according to an example of the present application.

FIG. 6 is a partial sectional view of a handheld power tool with an operating member at a third position according to an example of the present application.

FIG. 7 is a structural view of an operating member and a top shaft according to an example of the present application.

FIG. 8 is a structural view of a working attachment according to an example of the present application.

FIG. 9 is a structural view of a first type of lower flange according to an example of the present application.

FIG. 10 is a structural view of a second type of lower flange in an unlocked state according to an example of the present application.

FIG. 11 is a sectional view of a second type of lower flange in an unlocked state according to an example of the present application.

FIG. 12 is a structural view of a second type of lower flange in a locked state according to an example of the present application.

FIG. 13 is a sectional view of a second type of lower flange in a locked state according to an example of the present application.

FIG. 14 is a sectional view of a third type of lower flange in an unlocked state according to an example of the present application.

FIG. 15 is a sectional view of a third type of lower flange in a locked state according to an example of the present application.

FIG. 16 is an exploded view of a fourth type of lower flange according to an example of the present application.

FIG. 17 is a sectional view of a fourth type of lower flange according to an example of the present application.

FIG. 18 is a side view of a fourth type of lower flange with a cover removed according to an example of the present application.

FIG. 19 is a structural view of a cover in a fourth type of lower flange according to an example of the present application.

FIG. 20 is a structural view of a fourth type of lower flange with a wrench in a hidden state according to an example of the present application.

FIG. 21 is a structural view of a fourth type of lower flange with a wrench in a usage state according to an example of the present application.

FIG. 22 is a schematic view of a power tool according to an example of the present application.

FIG. 23 is a sectional view of the power tool in FIG. 22.

FIG. 24 is a partial view of the power tool in FIG. 22.

FIG. 25 is a perspective view of a position sensor.

FIG. 26 is an exploded view of a position sensor from a perspective.

FIG. 27 is a schematic view of a first housing and a pivot member.

FIG. 28 is an exploded view of a position sensor from another perspective.

FIG. 29 is a sectional view of the head of a power tool when an operating member is at a first position.

FIG. 30 is a sectional view of the head of a power tool when an operating member is at a second position.

FIG. 31 is a sectional view of the head of a power tool when an operating member is at a third position.

FIG. 32 is a sectional view of the head of a power tool when an operating member is restored from a third position to a first position.

FIG. 33 is a schematic view of an operating member in the examples disclosed in FIGS. 22 to 32.

FIG. 34 is a schematic view of the operating member in FIG. 33 during installation and use.

FIG. 35 is a sectional view of a ring gear assembly in a first state.

FIG. 36 is a sectional view of a ring gear assembly in a second state.

FIG. 37 is an exploded view of a ring gear assembly and a gearbox from a perspective.

FIG. 38 is an exploded view of a ring gear assembly and a gearbox from another perspective.

FIG. 39 is a schematic view of a ring gear assembly.

FIG. 40 is an exploded view of a ring gear assembly.

FIG. 41 is a schematic view of a quick release flange.

FIG. 42 is a sectional view of a quick release flange not mounted to a working attachment.

FIG. 43 is a sectional view of a quick release flange mounted to a working attachment.

FIG. 44 is an exploded view of a quick release flange.

FIG. 45 is an exploded view illustrating the installation of movable members in FIG. 44.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” “and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

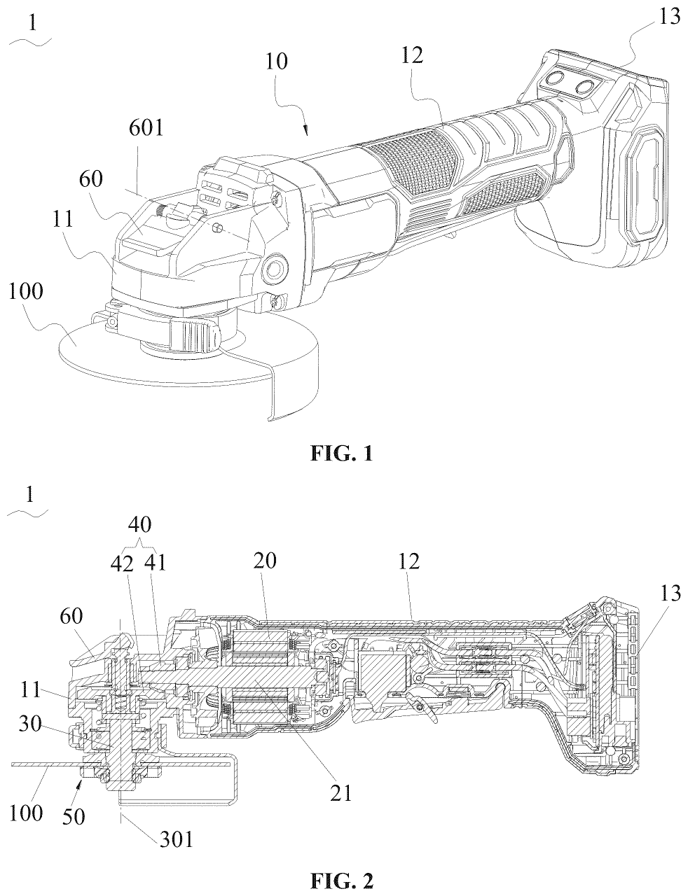

The present application provides a handheld power tool 1 that can be used for cutting and grinding. For example, the handheld power tool 1 may be an angle grinder. FIGS. 1 to 9 show the first example of the present application.

As shown in FIGS. 1 and 2, the handheld power tool 1 includes a housing 10, an electric motor 20, an output shaft 30, a transmission mechanism 40, and a mounting device 50. The electric motor 20 is disposed in the housing 10. The electric motor 20 includes or is connected to a motor shaft 21 so that the electric motor 20 outputs power. The transmission mechanism 40 connects the motor shaft 21 to the output shaft 30 so that the electric motor 20 drives the motor shaft 21 to rotate and the motor shaft 21 drives, through the transmission mechanism 40, the output shaft 30 to rotate about a first axis. The mounting device 50 is used for mounting a working attachment 100 to the output shaft 30 so that the output shaft 30 can drive the working attachment 100 to rotate.

The housing 10 includes a head housing 11 and a grip 12, and the head housing 11 is connected to the grip 12. In an example, the head housing 11 is perpendicular or approximately perpendicular to the grip 12. The electric motor 20 and the motor shaft 21 are disposed in the grip 12. Part of the output shaft 30 is disposed in the head housing 11. The motor shaft 21 is designed to be perpendicular or approximately perpendicular to the output shaft 30, and the transmission mechanism 40 connects the motor shaft 21 to the output shaft 30. When the motor shaft 21 rotates, the motor shaft 21 drives, through the transmission mechanism 40, the output shaft 30 to rotate, and then the output shaft 30 drives the working attachment 100 to rotate. The electric motor 20 rotates about the motor shaft. In this example, the motor shaft is basically perpendicular to the output shaft 30.

The transmission mechanism 40 includes a first bevel gear 41 and a second bevel gear 42. The first bevel gear 41 is mounted to the motor shaft 21 and can rotate synchronously with the motor shaft 21, and the second bevel gear 42 is mounted to the output shaft 30 and can drive the output shaft 30 to rotate synchronously. The first bevel gear 41 and the second bevel gear 42 mesh with each other so that when the motor shaft 21 rotates, the first bevel gear 41 drives the second bevel gear 42 to rotate, and the second bevel gear 42 drives the output shaft 30 to rotate synchronously, thereby achieving the vertical transmission between the motor shaft 21 and the output shaft 30.

The handheld power tool further includes an energy supply device mounted on the housing 10 or supported by the housing 10 and a control unit for controlling the operation of the handheld power tool. In an example, the energy supply device is a power line connected to the external mains power. In an example, the energy supply device may be a battery pack, a battery pack coupling portion 13 is formed on the housing 10, and the battery pack is detachably mounted to the battery pack coupling portion 13 and connected to the electric motor 20 so that the electric motor 20 is powered. The control unit is generally a circuit board assembly and is connected to the energy supply device and the electric motor 20 to control the operation of the handheld power tool.

The handheld power tool further includes an operating member 60 that can drive the output shaft 30 to move along the direction of a first axis 301 to lock or loosen the working attachment 100. That is, the working attachment 100 can be assembled and disassembled through the operating member 60 without the need for an additional disassembly and assembly tool, and the operation is simple and labor-saving.

The mounting device 50 includes an upper flange 51 and a lower flange 52. The upper flange 51 and the output shaft 30 are movably connected, and the lower flange 52 and the output shaft 30 may be threadedly connected or may mate with each other in other forms. When the working attachment 100 is mounted on the output shaft 30, the working attachment 100 is mounted between the upper flange 51 and the lower flange 52, and the upper flange 51 is closer to the operating member 60 than the lower flange 52.

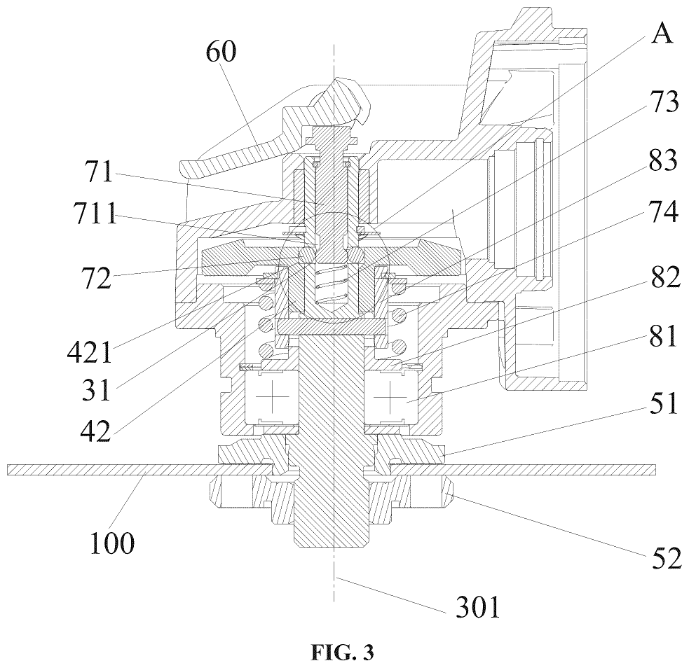

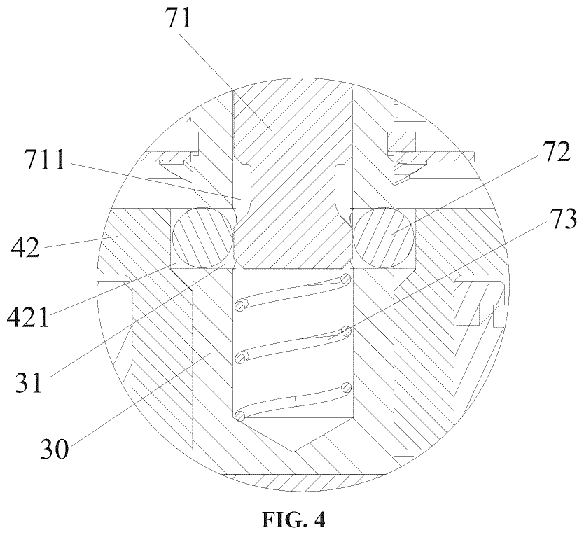

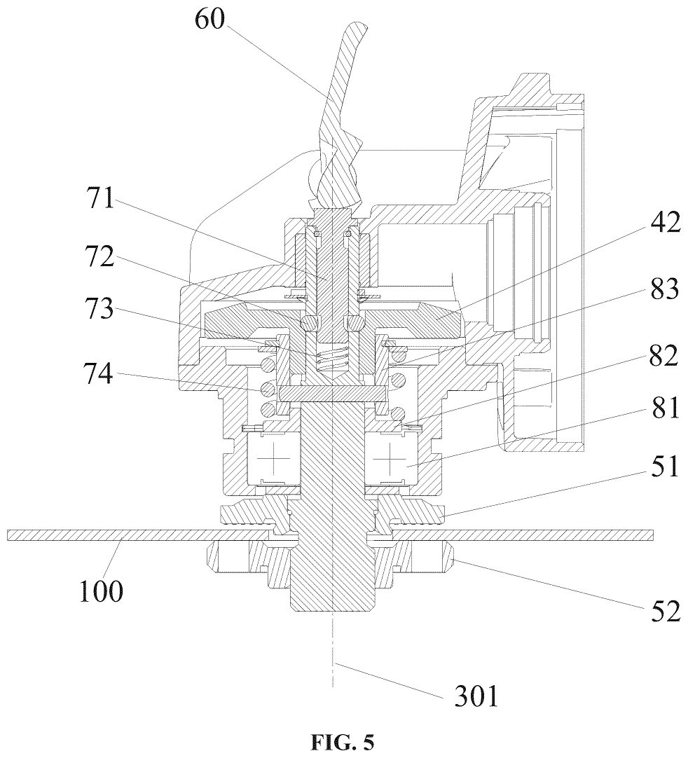

As shown in FIGS. 3 to 6, the operating member 60 has at least two positions, including a first position and a second position. Referring to FIGS. 3 and 4, when the operating member 60 is located at the first position, the working attachment 100 is locked. Referring to FIG. 5, when the operating member 60 moves from the first position to the second position, the output shaft 30 moves downward along the first axis 301 by a first preset distance, and the lower flange 52 moves downward along with the output shaft 30 by the first preset distance so that the distance between the upper flange 51 and the lower flange 52 increases. When the operating member 60 is located at the second position, the operator may mount the working attachment 100 to the output shaft 30 and then move the operating member 60 from the second position to the first position to reduce the distance between the upper flange 51 and the lower flange 52, thereby tightening the working attachment 100. In this manner, the working attachment 100 can perform operations such as cutting and grinding.

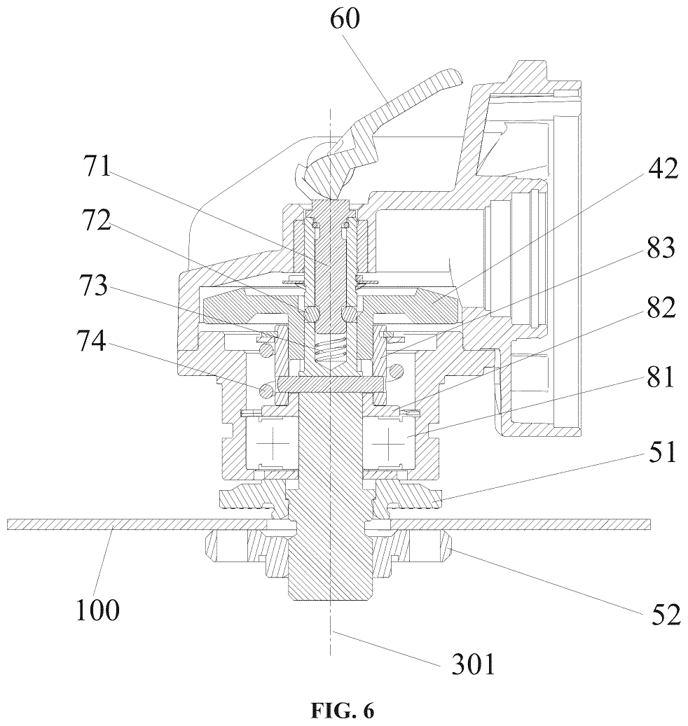

The operating member 60 may have a third position. When the operating member 60 moves from the first position to the third position, the output shaft 30 moves downward along the first axis 301 by a second preset distance. Referring to FIG. 6, when the operating member 60 is located at the third position, the distance between the upper flange 51 and the lower flange 52 further increases. The operator operates the lower flange 52, for example, unscrewing the lower flange 52, so that the working attachment 100 can be removed from the output shaft 30. The second preset distance is greater than the first preset distance. When the working attachment 100 needs to be mounted, the operating member 60 is switched from the first position to the second position, and after the working attachment 100 is mounted to the output shaft 30, the operating member 60 is reset to the first position. When the working attachment 100 needs to be removed, the operating member 60 is switched from the first position to the third position, and after the working attachment 100 is removed from the output shaft 30, the operating member 60 is reset to the first position.

It is to be noted that, to facilitate understanding of the principle of this solution, FIGS. 3, 5, and 6 are sectional views from the perspective shown in FIG. 1. At this operating angle, the upper flange 51 separates from the head housing 11 due to gravity and falls onto the working attachment 100. In actual operation, if the operator turns the handheld power tool upside down so that the operating member 60 faces downward and the working attachment 100 faces upward, the upper flange 51 naturally falls onto the head housing 11 due to gravity, presenting a gap between the upper flange 51 and the working attachment 100 shown in FIGS. 3, 5, and 6. The gap between the upper flange 51 and the working attachment 100, or the gap between the upper flange 51 and the lower flange 52, allows the operator to screw the lower flange 52 in or out by hand, eliminating the need to use an additional wrench attachment for the operation.

With continued reference to FIGS. 3 and 4, the handheld power tool further includes a top shaft 71, locking beads 72, and a first elastic member 73. The upper end surface of the output shaft 30 is provided with a countersunk hole, a portion of the top shaft 71 is disposed in the countersunk hole, a portion of the top shaft 71 exposed outside the countersunk hole mates with the operating member 60 to drive the output shaft 30, the outer wall of the top shaft 71 is provided with locking grooves 711, the sidewall of the output shaft 30 is provided with locking holes 31 connecting with the countersunk hole, the locking beads 72 are movably disposed in the locking holes 31, the locking beads 72 can mate with the locking grooves 711 to limit the movement distance of the output shaft 30, and the first elastic member 73 is disposed in the countersunk hole, is in a compressed state, and is disposed between the lower end of the top shaft 71 and the bottom wall of the countersunk hole.

The handheld power tool further includes a second elastic member 74 always in a compressed state to apply an elastic force to the output shaft 30, and when the output shaft 30 moves downward along the first axis 301, the output shaft 30 further compresses the second elastic member 74. Specifically, a bearing 81 supporting the rotation of the output shaft 30 is fixedly disposed in the head housing 11, a sleeve 82 and a bushing 83 are disposed on the outer circumference of the output shaft 30, the sleeve 82 is fixed on the bearing 81, the bushing 83 is fixedly connected to the output shaft 30, the bushing 83 is located above the sleeve 82, a first protrusion is disposed on the bushing 83, a second protrusion is disposed on the sleeve 82, and the second elastic member 74 is in the compressed state and is disposed between the first protrusion and the second protrusion. When the output shaft 30 moves downward, the output shaft 30 drives the bushing 83 to move downward, while the sleeve 82 does not move since the sleeve 82 is fixed on the bearing 81, so that the second elastic member 74 can be further compressed when the output shaft 30 moves downward.

Snap grooves 421 are provided on the inner wall of the second bevel gear 42. When the operating member 60 is located at the first position, the snap grooves 421 connect with the locking holes 31 on the output shaft 30.

Referring to FIGS. 3 and 4, when the operating member 60 is located at the first position, the locking grooves 711 on the top shaft 71 are higher than the locking holes 31 on the output shaft 30. At this time, the locking beads 72 are simultaneously located in the locking holes 31 of the output shaft 30 and the snap grooves 421 of the second bevel gear 42. In this manner, when the load is relatively large, the locking beads 72 are limited by the snap grooves 421 on the second bevel gear 42 so that the output shaft 30 cannot be pulled down, thereby ensuring the operation stability. As shown in FIG. 5, when the operating member 60 is switched from the first position to the second position, the operating member 60 drives the top shaft 71 to move downward against the elastic force of the first elastic member 73. When the top shaft 71 moves downward to the point where the locking grooves 711 connect with the locking holes 31 on the output shaft 30, the locking beads 72 move, and part of the locking bead 72 moves into the locking groove 711. At this time, the locking beads 72 are located in both the locking holes 31 and the locking grooves 711, that is, the locking beads 72 lock the output shaft 30 and the top shaft 71 as a whole. At this time, the operating member 60 drives the top shaft 71 and the output shaft 30 to move downward together. After the output shaft 30 moves downward by the first preset distance, the working attachment 100 can be mounted onto the output shaft 30 through the mounting device 50. When the working attachment 100 is mounted in place, the operating member 60 is reset to the first position, the top shaft 71 is reset by the restoring force of the first elastic member 73, the output shaft 30 is reset by the restoring force of the second elastic member 74, and the locking beads 72 leave the locking grooves 711 and return to the locking holes 31 and the snap grooves 421. At this time, the working attachment 100 is locked.

As shown in FIG. 6, when the operating member 60 is switched from the first position to the third position, the principle is the same as the principle when the operating member 60 is switched from the first position to the second position, and the details are not repeated here. The only difference is that the movement distance of the output shaft 30 is the second preset distance in this case. After the output shaft 30 moves downward in place, the working attachment 100 can be removed from the output shaft 30, and then the operating member 60 is reset to the first position. The resetting principle is the same as the resetting principle when the operating member 60 is reset from the second position to the first position, and the details are not repeated here. In this example, the second preset distance is greater than the first preset distance. In this manner, the following problem can be avoided: the working attachment 100 is difficult to remove since the working attachment 100 is tightened after working for a long time. In an example, the first preset distance is approximately 1 mm, and the second preset distance is approximately 2 mm. The “approximately” here means that the specific parameter value may fluctuate up or down by 20%.

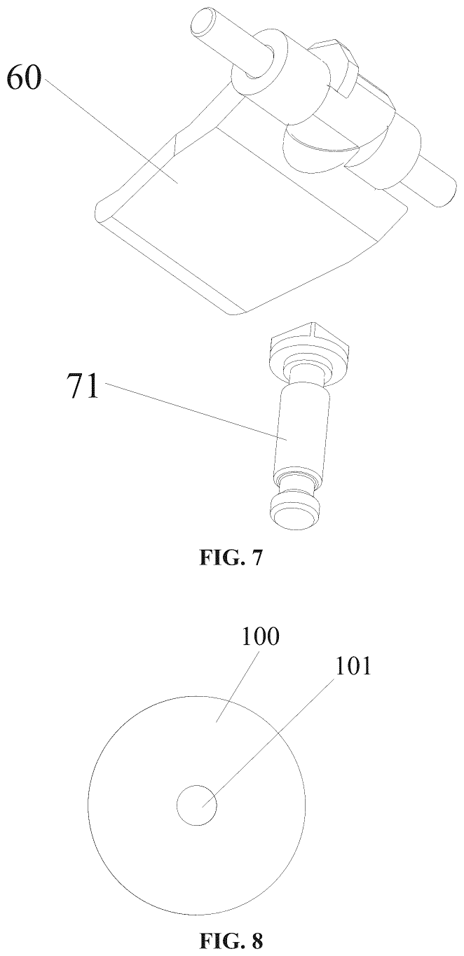

As shown in FIG. 7, the operating member 60 is in shape fit or concave-convex fit with the top shaft 71 so that when the operating member 60 rotates to the positions for making the working attachment 100 loosened (that is, the second position and the third position), the top shaft 71 does not rotate relative to the operating member 60, and thus the output shaft 30 does not rotate. In this manner, when the lower flange 52 rotates on the output shaft 30, the output shaft 30 does not rotate along with the lower flange 52 so that the operator can smoothly mount the working attachment 100 to the output shaft 30 or remove the working attachment 100 from the output shaft 30.

The operating member 60 is rotatable about a second axis 601. The second axis 601 is basically perpendicular to the first axis 301, or the second axis 601 is basically parallel to the first axis 301. In this example, in the solution disclosed in FIGS. 1 and 2, the second axis 601 is basically perpendicular to the first axis 301. In another example, the second axis 601 may be basically parallel to the first axis 301. In this case, the contact portion between the operating member 60 and the top shaft 71 has a height difference so that when the operating member 60 rotates about the second axis 601, the operating member 60 can drive the top shaft 71 to move in the up and down direction.

During the movable stroke of the operating member 60, the maximum pressure applied to the output shaft 30 is greater than or equal to 80 N. The maximum elastic force that the second elastic member 74 can provide is greater than or equal to 200 N so that when the operating member 60 is at the first position, the second elastic member 74 can provide a sufficiently large elastic force to prevent the lower flange 52 from loosening. Moreover, it can be ensured that when the operating member 60 is at the third position, the elastic force provided by the second elastic member 74 is not too large, thereby avoiding the problem of being unable to move the operating member 60.

In an example, the elastic force provided by the second elastic member 74 at the first position is approximately 160 N, and the elastic force provided by the second elastic member 74 at the third position is approximately 200 N. In another example, the elastic force provided by the second elastic member 74 at the first position is approximately 220 N, and the elastic force provided by the second elastic member 74 at the third position is approximately 270 N.

It is to be understood that the operating member 60 may be in a form other than a wrench handle in this example, such as a key or a button. In an example, two types of operating members 60 may be provided, such as a wrench handle and a button, which are provided separately and used together, the wrench handle is configured to implement the function of loosening the working attachment 100, and the button is configured to implement the function of locking the working attachment 100.

As shown in FIG. 8, a mounting port 101 of the compatible working attachment 100 may be a standard circular hole, eliminating the need to adapt to the working attachment 100 with the mounting port 101 of a special shape, so that the technical solution disclosed in the present application is widely applicable and saves costs for the user. In other examples, the mounting port 101 of the compatible working attachment 100 only needs to be a circular hole, and the working attachment 100 can be mounted and used regardless of whether the dimension of the mounting port 101 is the dimension of a standard circular hole on the market or the dimension of a customized circular hole.

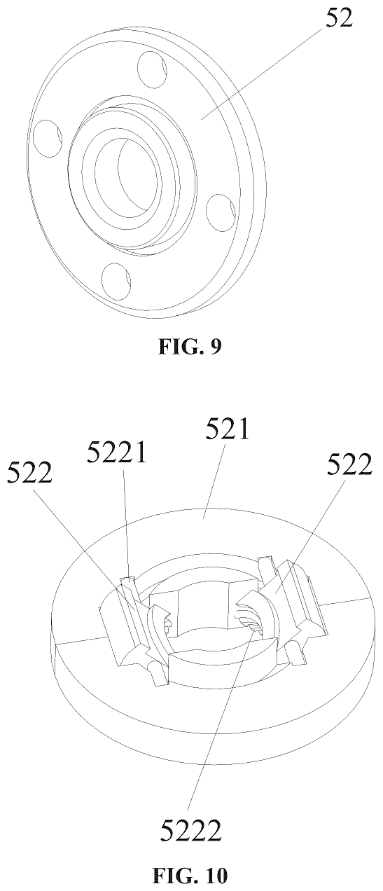

As shown in FIG. 9, the lower flange 52 may be a common internally threaded flange. Alternatively, as shown in FIGS. 10 to 15, the structure of the lower flange 52 may include a flange body 521 and two movable members 522, the two movable members 522 are opposite to each other and disposed on the flange body 521, and each of the ends of the two movable members 522 that are adjacent to each other is provided with a mating portion 5222 mating with the external threads of the output shaft 30. In an example, the mating portion 5222 has internal threads. In an example, the mating portions 5222 may be in shape fit with each other. For example, the mating portions 5222 may be in concave-convex fit with each other. The movable member 522 has a locked state in which the movable member 522 is connected to the output shaft 30 and an unlocked state in which the movable member 522 is detached from the output shaft 30. The movable member 522 switches to the locked state when the movable member 522 abuts against the working attachment 100, and the movable member 522 switches to the unlocked state when the movable member 522 is detached from the working attachment 100.

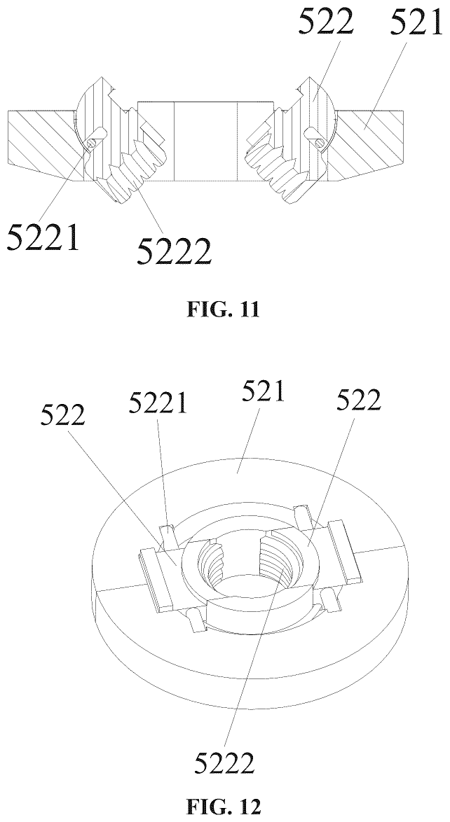

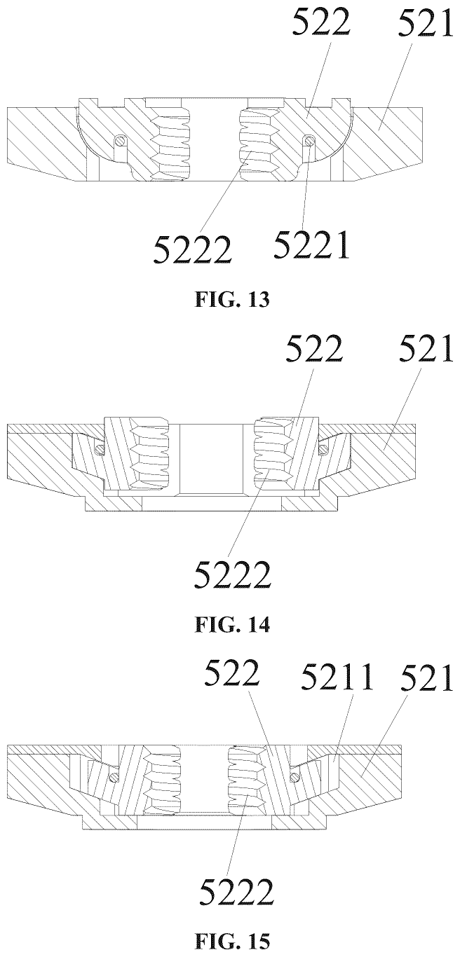

Specifically, referring to FIGS. 10 to 13, the movable member 522 is mounted on the flange body 521 via a rotary shaft 5221, the movable member 522 is rotatable about the axis of the rotary shaft 5221, and the axis of the rotary shaft 5221 is perpendicular to the first axis. When the lower flange 52 is not mounted on the output shaft 30 (that is, the movable members 522 do not abut against the working attachment 100), the movable members 522 are in the unlocked state. Referring to FIGS. 10 and 11, in this case, the ends of the two movable members 522 that are away from each other both protrude from the upper surface of the flange body 521, and the distance between the ends of the two movable members 522 that are adjacent to each other is greater than the outer diameter of the output shaft 30. In this case, the output shaft 30 may pass through the two movable members 522. After the movable members 522 abut against the working attachment 100, the movable members 522 rotate about the rotary shafts 5221, and the movable members 522 switch to the locked state. Referring to FIGS. 12 and 13, the internal threads of the ends of the two movable members 522 that are adjacent to each other mate with the external threads on the output shaft 30. In this case, the lower flange 52 does not need to be rotated, or the lower flange 52 only needs to be rotated a smaller number of circles to lock the lower flange 52.

As shown in FIGS. 14 and 15, alternatively, sliding grooves 5211 may be obliquely disposed on the flange body 521, the movable member 522 is movable along the sliding groove 5211, and the sliding groove 5211 and the first axis are arranged at an included angle to each other. When the movable member 522 moves in the sliding groove 5211, the movable member 522 is capable of being displaced along the direction of the first axis. When the lower flange 52 is not mounted on the output shaft 30 (that is, the movable members 522 do not abut against the working attachment 100), the movable members 522 are in the unlocked state. Referring to FIG. 14, in this case, the movable members 522 are located at the distal ends of the sliding grooves 5211, the top ends of the two movable members 522 both protrude from the upper surface of the flange body 521, and the distance between the ends of the two movable members 522 that are adjacent to each other is greater than the outer diameter of the output shaft 30. In this case, the output shaft 30 may pass through the two movable members 522. After the movable members 522 abut against the working attachment 100, the movable members 522 slide along the sliding grooves 5211 to the proximal ends of the sliding grooves 5211, and the movable members 522 switch to the locked state. Referring to FIG. 15, the internal threads of the ends of the two movable members 522 that are adjacent to each other mate with the external threads on the output shaft 30. In this case, the lower flange 52 does not need to be rotated, or the lower flange 52 only needs to be rotated a smaller number of circles to lock the lower flange 52.

The present application provides the two structures of the lower flange 52 so that the lower flange 52 can be quickly mounted and removed, thereby saving time for mounting and removing the lower flange 52.

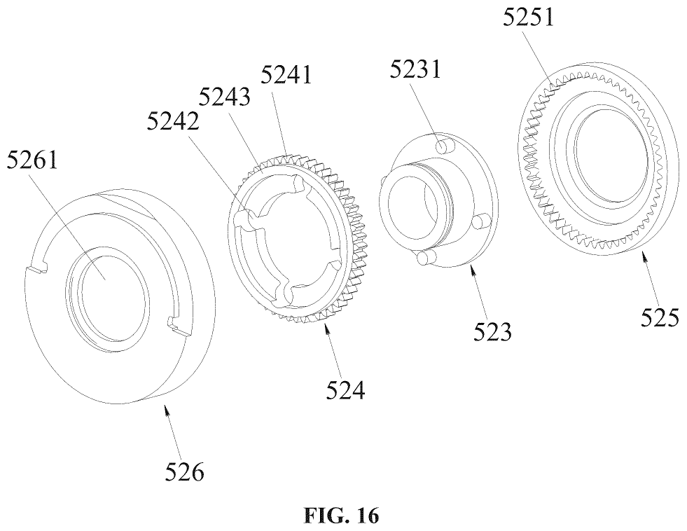

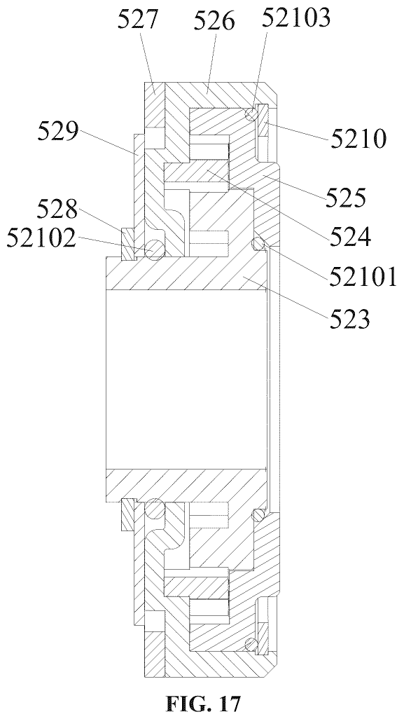

In addition, the present application further provides a labor-saving lower flange 52. As shown in FIGS. 16 and 17, the labor-saving lower flange 52 includes a gear carrier 523, an internal gear 524, an external ring gear 525, and a cover 526. The gear carrier 523 has a central threaded hole and multiple positioning portions 5231 distributed circumferentially around the central threaded hole. The internal gear 524 is sleeved on the gear carrier 523. The internal gear 524 is provided with multiple coupling portions 5242 that are in one-to-one plug-in fit with the multiple positioning portions 5231. The inner diameter of the coupling portion 5242 is greater than the diameter of the positioning portion 5231. The internal gear 524 has external teeth 5241. The external ring gear 525 has internal teeth 5251. The pitch circle diameter of the external ring gear 525 is greater than the pitch circle diameter of the internal gear 524. The internal gear 524 is mounted inside the external ring gear 525, and the internal gear 524 and the external ring gear 525 are not concentric. The external teeth 5241 can mesh with the internal teeth 5251, and the number of external teeth 5241 is less than the number of internal teeth 5251. The cover 526 is disposed outside the external ring gear 525, and an end of the external ring gear 525 along the axial direction of the central threaded hole protrudes from the cover 526. The relative movement between the gear carrier 523, the internal gear 524, the external ring gear 525, and the cover 526 along the axial direction of the central threaded hole is restricted. A drive structure is provided between the cover 526 and the internal gear 524. When the cover 526 is rotated, the cover 526 can drive, through the drive structure, the internal gear 524 to rotate about the center of the external ring gear 525 in the external ring gear 525, and the internal gear 524 can drive the gear carrier 523 to rotate about the axis of the gear carrier 523.

A small-tooth-difference reduction structure formed by the internal gear 524 and the external ring gear 525 is disposed inside the flange. When the lower flange 52 is mounted on the output shaft 30, the external ring gear 525 abuts against the working attachment 100 and is fixed. In this case, the cover 526 is rotated, the cover 526 can drive, through the drive structure, the internal gear 524 to rotate about the center of the external ring gear 525 in the external ring gear 525, and the internal gear 524 further drives the gear carrier 523 to rotate about the axis of the gear carrier 523 to tighten or loosen the threads. The small-tooth-difference reduction structure formed by the internal gear 524 and the external ring gear 525 plays a role in reducing speed and increasing torque. The flange can be tightened or loosened without the aid of tools, and the operation is simple and labor-saving. In an example, the lower flange 52 can amplify the torque by more than 30 times so that the user can directly tighten or loosen the flange 52 by hand. The deceleration principle of the small-tooth-difference reduction structure is the existing art, and the details are not repeated here.

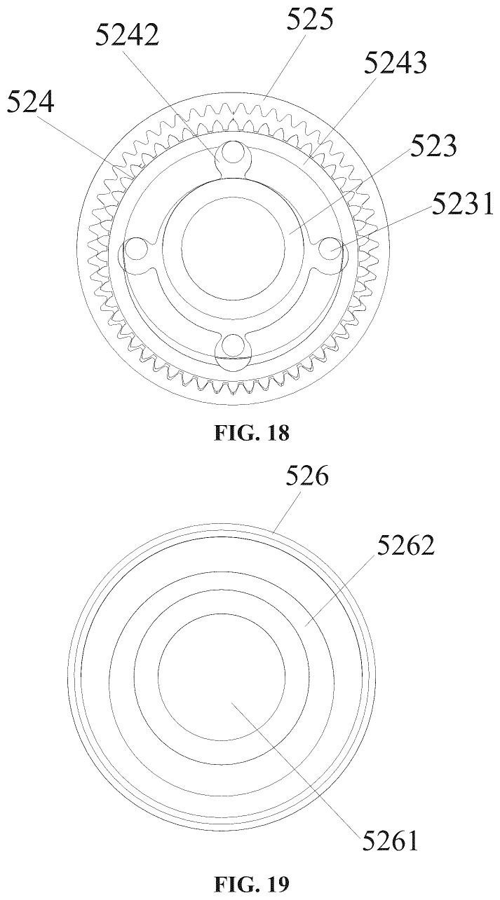

As shown in FIGS. 18 and 19, the cover 526 has a central mounting port 5261, the cover 526 is sleeved on the gear carrier 523 through the central mounting port 5261, the inner end surface of the cover 526 is provided with an eccentric groove 5262 surrounding the central mounting port 5261, an eccentric protrusion 5243 is disposed at an end of the internal gear 524 facing the cover 526, and the eccentric protrusion 5243 is plugged into the eccentric groove 5262 to form the preceding drive structure. When the cover 526 is rotated, the cover 526 drives, through the drive structure formed by the eccentric groove 5262 and the eccentric protrusion 5243, the internal gear 524 to rotate about the center of the external ring gear 525 in the external ring gear 525. Since the inner diameter of the coupling portion 5242 on the internal gear 524 is greater than the diameter of the positioning portion 5231 on the gear carrier 523, the rotating internal gear 524 is displaced relative to the gear carrier 523 and can drive the gear carrier 523 to rotate about the axis of the gear carrier 523.

With continued reference to FIGS. 16 and 17, the center of the external ring gear 525 has a stepped hole, the stepped hole includes a first step portion, a second step portion, and a third step portion whose diameters decrease in sequence, the internal teeth are disposed on the inner circumferential wall of the first step portion, the internal gear 524 is mounted in the first step portion, the gear carrier 523 is mounted in the second step portion, and the third step portion is opposite to the central threaded hole. Through the preceding structural arrangement, the external ring gear 525 can limit the internal gear 524 and the gear carrier 523 from the first side along the axial direction of the central threaded hole. In addition, the cover 526 can limit the internal gear 524, the gear carrier 523, and the ring gear from the second side opposite to the first side along the axial direction of the central threaded hole. In addition, a first retaining ring 528 is fixed to the gear carrier 523, and the first retaining ring 528 is used for limiting the cover 526 from the second side of the central threaded hole. Optionally, an elastic gasket 529 is disposed between the first retaining ring 528 and the cover 526 to protect the cover 526. A second retaining ring 5210 is fixed to the inner wall surface of the cover 526, and the second retaining ring 5210 is used for limiting the external ring gear 525 from the first side along the axial direction of the central threaded hole. Through the preceding structural arrangement, the relative movement between the gear carrier 523, the internal gear 524, the external ring gear 525, and the cover 526 along the axial direction of the central threaded hole is restricted.

A connecting surface is provided between the second step portion and the third step portion, and a first sealing ring 52101 is disposed between the connecting surface and the gear carrier 523. A second sealing ring 52102 is disposed between the first retaining ring 528 and the outer end surface of the cover 526. A third sealing ring 52103 is disposed between the second retaining ring 5210 and the outer end surface of the external ring gear 525. By providing the first sealing ring 52101, the second sealing ring 52102, and the third sealing ring 52103, when the external ring gear 525 does not abut against the working attachment 100, all parts do not rotate relative to each other due to the friction force, thereby ensuring that the flange rotates as a whole quickly until the external ring gear 525 abuts against the working attachment 100.

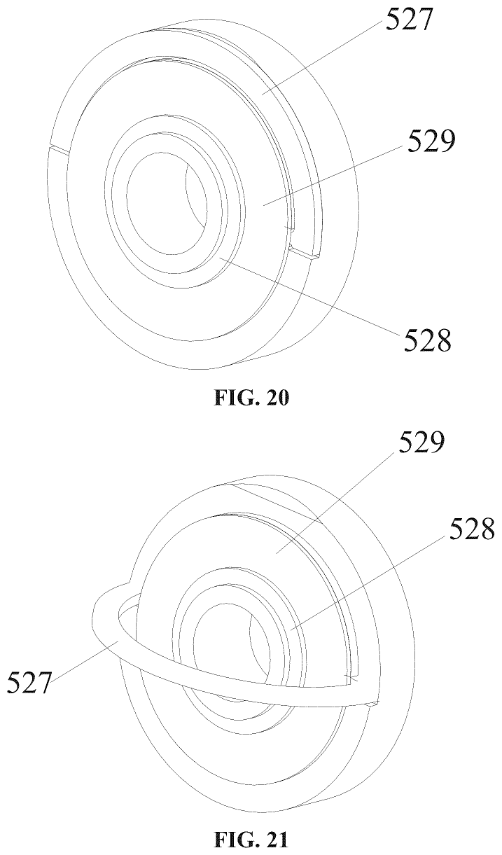

As shown in FIGS. 20 and 21, a wrench 527 is disposed on the cover 526, and the cover 526 can be rotated by pulling the wrench 527. Furthermore, the wrench 527 has a hidden state and a usage state, and the wrench 527 can be rotated relative to the cover 526 to switch between the hidden state and the usage state. When the cover 526 needs to be rotated, the wrench 527 is switched to the usage state, and when the cover 526 does not need to be rotated, the wrench 527 is rotated to the hidden state to save space.

It is to be noted that the lower flange 52 disclosed in the present application can be applied not only to the angle grinder but also to another power tool to which the working attachment 100 needs to be mounted, such as a mower to which blades need to be mounted.

However, the solution described above may cause a case where the user may mount the working attachment 100 to a wrong position, resulting in the following: when the operating member 60 is adjusted back to the working position, the working attachment 100 is locked too tight and cannot be removed after the work is completed.

Therefore, the present application further designs the technical solution below. A power tool 2 includes an electric motor 20, and the electric motor 20 includes a rotatable motor shaft 21. The power tool 2 further includes a mounting assembly 500. The mounting assembly 500 includes an output shaft 30, and the output shaft 30 extends along a first axis 301. When the power tool 2 is in the operating state, a working attachment 500 is mounted to the output shaft 30 and performs an operation. The operation types here include grinding, cutting, and other types. The output shaft 30 is rotatable about the first axis 301 or reciprocates. The rotation may be eccentric rotation or non-eccentric rotation. The mounting assembly 500 has a mounted state and a non-mounted state. When the working attachment 100 in the mounted state is mounted to the output shaft 30, if the electric motor 20 is started, the working attachment 100 is movable along with the output shaft 30.

The power tool 2 further includes an anti-misinstallation mechanism 90. The anti-misinstallation mechanism 90 allows the output shaft 30 to rotate after the working attachment 100 in the mounted state is mounted to the output shaft 30; and the anti-misinstallation mechanism 90 prevents the output shaft 30 from rotating after the working attachment 100 in the non-mounted state is mounted to the output shaft 30. In an example, after the working attachment 100 in the non-mounted state is mounted to the output shaft 30, the anti-misinstallation mechanism 90 prevents the electric motor 20 from being electrically started. In another example, after the working attachment 100 in the non-mounted state is mounted to the output shaft 30, if the electric motor 20 is started, the anti-misinstallation mechanism 90 interrupts the transmission connection between the output shaft 30 and the motor shaft 21.

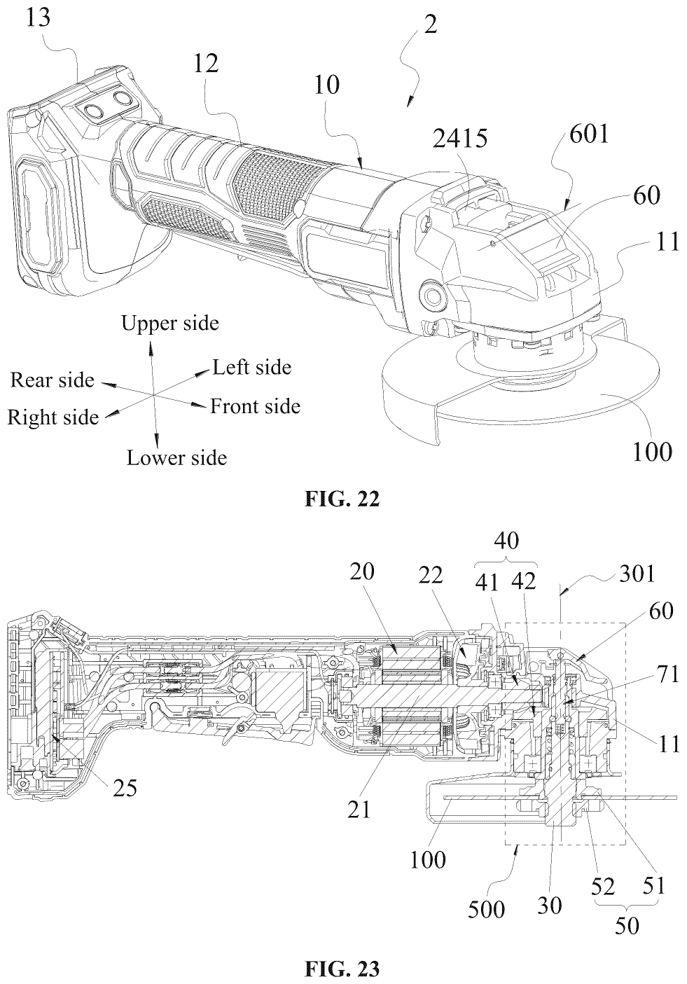

FIGS. 22 to 34 show the second example of the present application. In the second specific example, the same reference numerals as those in the first specific example denote the same parts. The same or repeated parts as those in the first example (especially FIGS. 22 and 23 and FIGS. 29 to 32) are not repeated, and only the parts different from those in the first example are described.

As shown in FIG. 22, the present application provides a power tool 2, and the power tool 2 may be used for cutting and grinding. For example, the power tool 2 may be an angle grinder. The power tool 2 may be a handheld power tool or another type of power tool.

FIG. 23 is a sectional view of the power tool 2. The power tool 2 includes a mounting assembly 500. The mounting assembly 500 includes an output shaft 30, and the output shaft 30 is rotatable about a first axis 301. The mounting assembly 500 has a mounted state in which the working attachment 100 can be mounted to the output shaft 30. When the mounting assembly 500 is in the mounted state, if the output shaft 30 is mounted to the working attachment 100, the electric motor 20 can be started normally after the operating member 60 is reset.

The mounting assembly 500 further includes a top shaft 71 that can be driven by the operating member 60 to move to drive the output shaft 30 to move. The output shaft 30 moves along the direction of the first axis 301 to lock or loosen the working attachment 100 and the output shaft 30. The function and position of the operating member 60 and the transmission manner between the top shaft 71 and the output shaft 30 are basically the same as those in the first example, and the details are not repeated here. It is to be noted that the dashed box of the mounting assembly 500 marked in FIG. 23 roughly indicates the mounting assembly.

The mounting assembly 500 further has a non-mounted state. When the mounting assembly 500 is in the non-mounted state, if the output shaft 30 is mounted to the working attachment 100, the electric motor 20 cannot be started normally after the operating member 60 is reset. The power tool 2 is configured in this manner to ensure that the working attachment 100 is mounted in a correct mounted state, thereby preventing the working attachment 100 from being unable to be removed due to incorrect installation. Therefore, in the present application, the anti-misinstallation mechanism 90 is provided so that when the mounting assembly 500 is in the non-mounted state, the anti-misinstallation mechanism 90 prevents the electric motor 20 from starting.

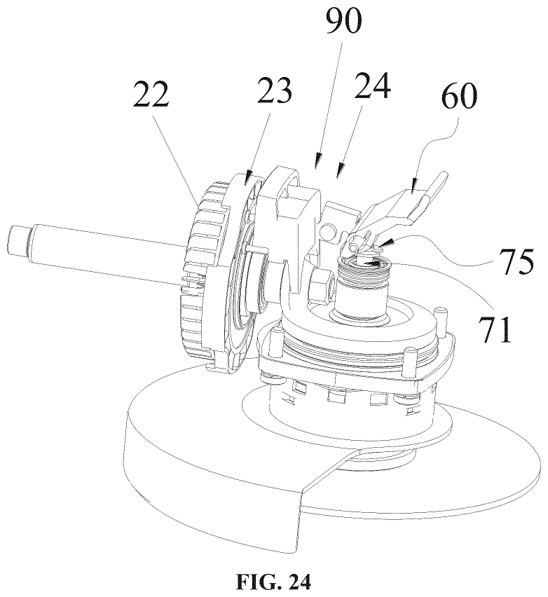

FIGS. 24 to 32 introduce the first example of the anti-misinstallation mechanism 90, that is, a position sensor 24.

As shown in FIG. 24, the power tool 2 further includes the position sensor 24 for identifying the position of the operating member 60. Specifically, since the operating member 60 is rotatable, the position sensor 24 can identify the position to which the operating member 60 is rotated in the current state. The power tool 2 further includes a fan 22 located between the electric motor 20 and the position sensor 24 so that the fan 22 can dissipate heat for the electric motor 20 and the position sensor 24 at the same time. The power tool 2 further includes the electric motor 20 for driving an output shaft 30 to rotate. The position sensor 24 is disposed between the electric motor 20 and an end 61 of the operating member 60. A fan housing 23 is disposed on the front side of the fan 22, and the fan housing 23 mounts the fan 22 to the housing 10. Specifically, the fan housing 23 mounts the fan 22 to the housing 10 of the power tool 2 near the head housing 11 by means of screws. In an example, the position sensor 24 is disposed between the electric motor 20 and the first axis 301.

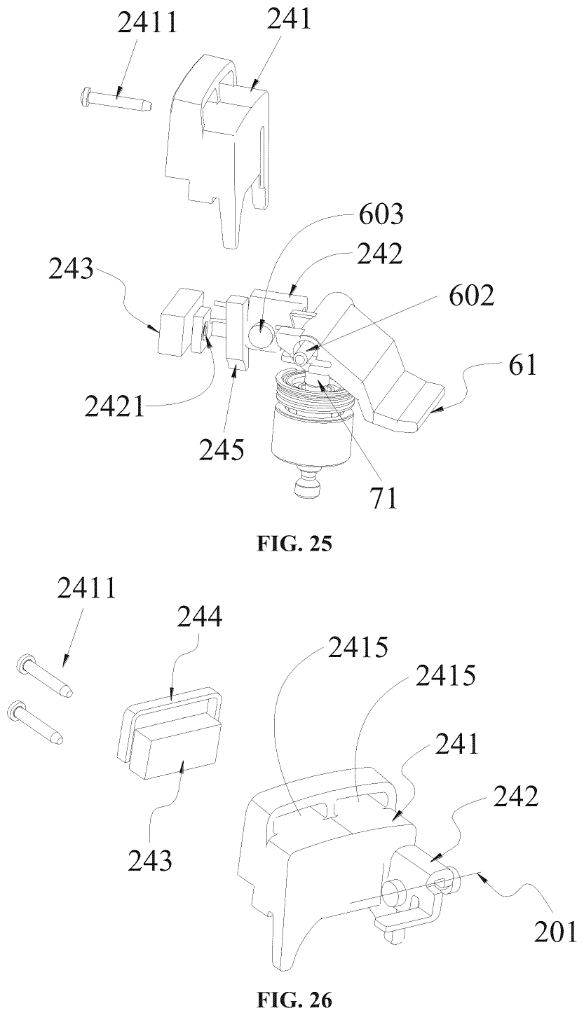

FIGS. 25 to 28 further disclose the specific structure and working principle of the position sensor 24.

The position sensor 24 includes a first sensing element 243 and a second sensing element 2421. Different from the examples in FIGS. 1 to 9, a limiting portion 75 is disposed on the top shaft 71, the limiting portion 75 is movable along with the top shaft 71, and the movement of the limiting portion 75 enables the position sensor 24 to recognize the movement of the top shaft 71, thereby determining the position of the top shaft 71. Specifically, the limiting portion 75 may be a circlip clamped on the outer circumference of the top shaft 71, or the limiting portion 75 and the top shaft 71 may be fixed in other process methods.

The position sensor 24 further includes a movable pivot member 242, and the second sensing element 2421 is disposed on the pivot member 242. The movement of the pivot member 242 enables the second sensing element 2421 to move relative to the first sensing element 243. A second pin 603 passes through the pivot member 242 so that the pivot member 242 is rotatable about a third axis 201 (referring to FIG. 26) extending along the second pin 603. The pivot member 242 further includes a driving portion 2422, and the limiting portion 75 moves to directly drive the driving portion 2422 to rotate about the third axis 201. The driving portion 2422 and the second sensing element 2421 are located on two sides of the third axis 201 so that the driving portion 2422 moves to directly cause the second sensing element 2421 to move, the top shaft 71 moves to drive the second sensing element 2421 to move, and thus the position sensor 24 can sense the position of the top shaft 71. In this example, the second sensing element 2421 is accommodated in a second accommodation portion 2423, the driving portion 2422 is configured to be a long strip protruding outward or may be configured to be other shapes, and the driving portion 2422 and the second accommodation portion 2423 may be integrally formed or may be separately formed.

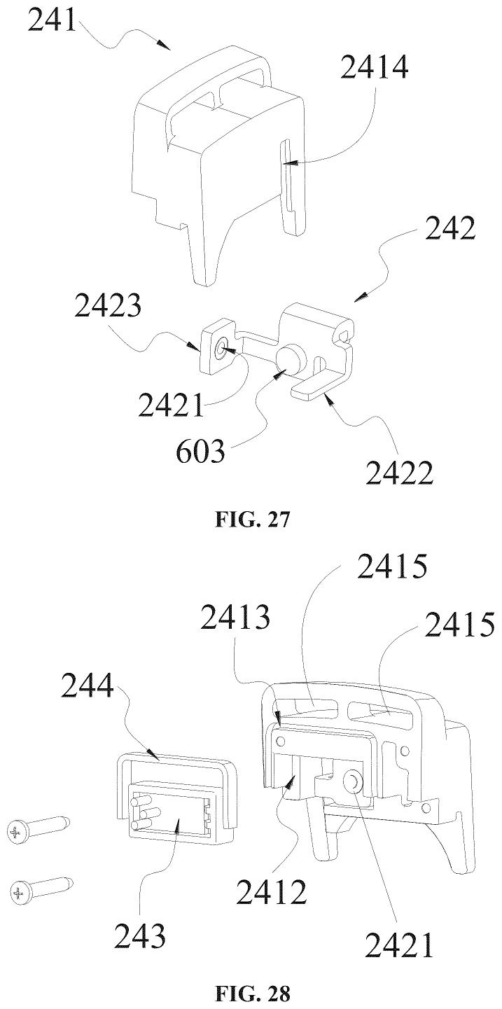

The position sensor 24 includes a first housing 241, and the first sensing element 243 is accommodated in the first housing 241. The first housing 241 and the fan housing 23 are fixed by screws 2411. A first accommodation portion 2412 is formed in the first housing 241, and the first sensing element 243 is disposed in the first accommodation portion 2412. A sealing groove 2413 is disposed on the outer periphery of the first accommodation portion 2412, and a first sealing member 244 is disposed in the sealing groove 2413. In an example, the first sealing member 244 is made of a deformable flexible material, such as felt cloth, and the first sealing member 244 is inserted into the sealing groove 2413 to prevent dust and the like from entering the first sensing element 243. As shown in FIGS. 25 and 27, the first housing 241 is further provided with a channel 2414 for the pivot member 242 to move, and the remaining portion of the channel 2414 is filled with a second sealing member 245 for implementing sealing and shock absorbing functions. In this example, the first housing 241 is provided with two vents 2415. As shown in FIG. 1, the heat dissipation air flowing out of the electric motor 20 flows out of the power tool 2 through the vents 2415.

In a specific example, the position sensor 24 is a Hall position sensor, the first sensing element 243 is a Hall plate, and the second sensing element 2421 is a magnetic member.

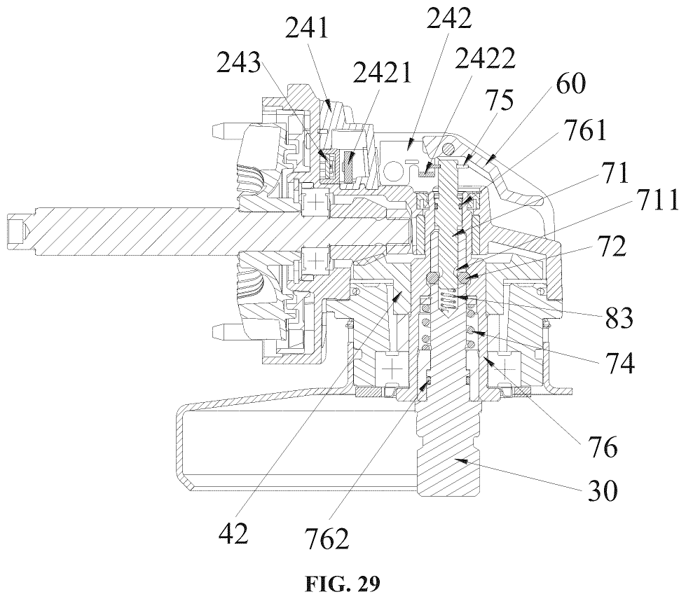

FIGS. 29 to 32 disclose the movement changes of the position sensor 24 when the operating member 60 of the power tool 2 is at different positions. The components in FIGS. 29 to 32 with the same reference numerals as those in FIGS. 1 to 9 have the same working principles as those in the first example, and the details are not repeated. The working principles may be understood by referring to the textual descriptions of FIGS. 1 to 9.

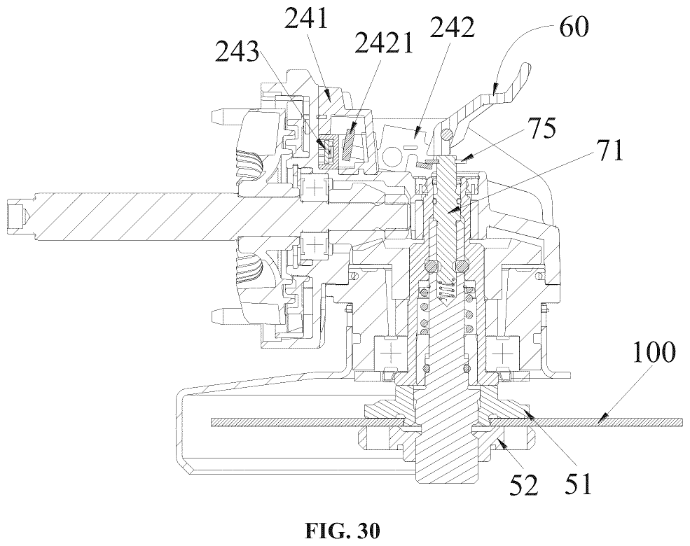

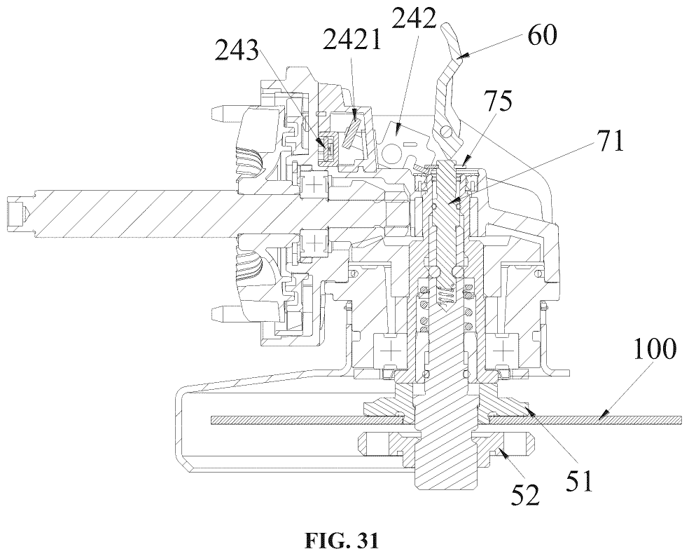

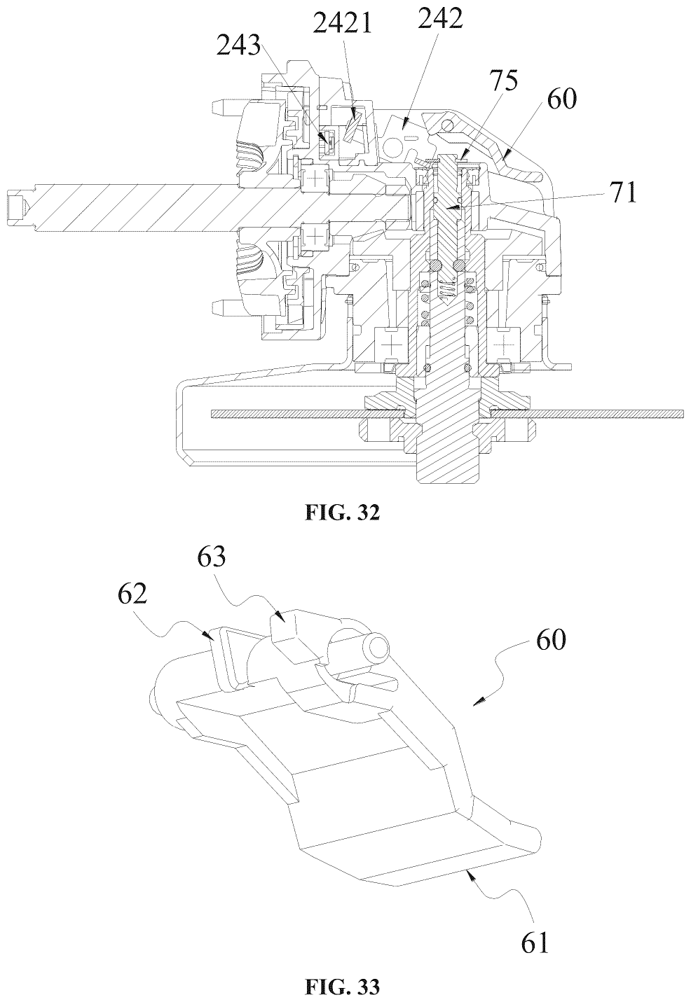

The operating member 60 in FIGS. 29 and 32 is located at the first position, the operating member 60 in FIG. 30 is located at the second position, and the operating member 60 in FIG. 31 is located at the third position. As shown in FIG. 29, the operating member 60 is located at the first position, and the working attachment 100 is not mounted on the output shaft 30. At this position, the limiting portion 75 is separated from the driving portion 2422, and the distance between the second sensing element 2421 and the first sensing element 243 is the shortest.

As shown in FIG. 30, when the user pulls the operating member 60 to the second position, the limiting portion 75 moves downward with the top shaft 71, the limiting portion 75 drives the driving portion 2422 to move downward, the second sensing element 2421 is lifted upward, and the distance between the second sensing element 2421 and the first sensing element 243 is greater than that in FIG. 29. In this state, the user mounts the upper flange 51, the working attachment 100, and the lower flange 52 onto the output shaft 30 and pulls the operating member 60 back to the first position, the output shaft 30 moves upward, and the working attachment 100 is more firmly mounted on the output shaft 30.

As shown in FIG. 31, when the working attachment 100 needs to be removed, the operating member 60 is directly pulled to the third position, and the output shaft 30 moves downward to the lowest end so that a gap is formed between the lower flange 52 and the working attachment 100, making it convenient for the user to unscrew the lower flange 52 and remove the working attachment 100. At this position, compared with the state in FIG. 30, the top shaft 71 moves downward, the limiting portion 75 moves downward with the top shaft 71, the limiting portion 75 drives the driving portion 2422 to move downward, the second sensing element 2421 is lifted upward, and the distance between the second sensing element 2421 and the first sensing element 243 is greater than that in FIG. 30.

FIG. 32 illustrates a manner in which the working attachment 100 is incorrectly mounted. If the user mounts the working attachment 100 when the operating member 60 is located at the third position, when the user pulls the operating member 60 back to the first position, the second sensing element 2421 cannot be reset to the position shown in FIG. 29. The reason is that when the operating member 60 is located at the third position, the output shaft 30 moves downward to the bottom; and when the user mounts the working attachment 100 and pulls the operating member 60 back to the first position, the working attachment 100 is mounted too tightly. After the electric motor 20 is started and the working attachment 100 rotates, the working attachment 100 is often mounted more tightly. As a result, when the user finishes using the working attachment 100 and wants to remove the working attachment 100, the user finds that the working attachment 100 cannot be removed directly but requires additional tools and a series of complicated operations to remove the working attachment 100.

In the present application, the third position is provided for the user to operate the operating member 60 to remove the working attachment 100 instead of mounting the working attachment 100 at this position. To prevent the user from mounting the working attachment 100 at a wrong position, the power tool 2 is provided with the position sensor 24 for acquiring the position of the operating member 60. In this example, the position sensor 24 determines the position state of the operating member 60 through the position change of the top shaft 71. The power tool 2 further includes a control board 25 (referring to FIG. 23). The control board 25 includes electronic components for controlling the operation of the electric motor 20. The change in the electrical signal generated by the relative position relationship between the first sensing element 243 and the second sensing element 2421 is transmitted to the control board 25. When the user mounts the working attachment 100 when the operating member 60 is at the third position, the control board 25 controls the electric motor 20 to be unable to start, thereby preventing the working attachment 100 from being mounted incorrectly.

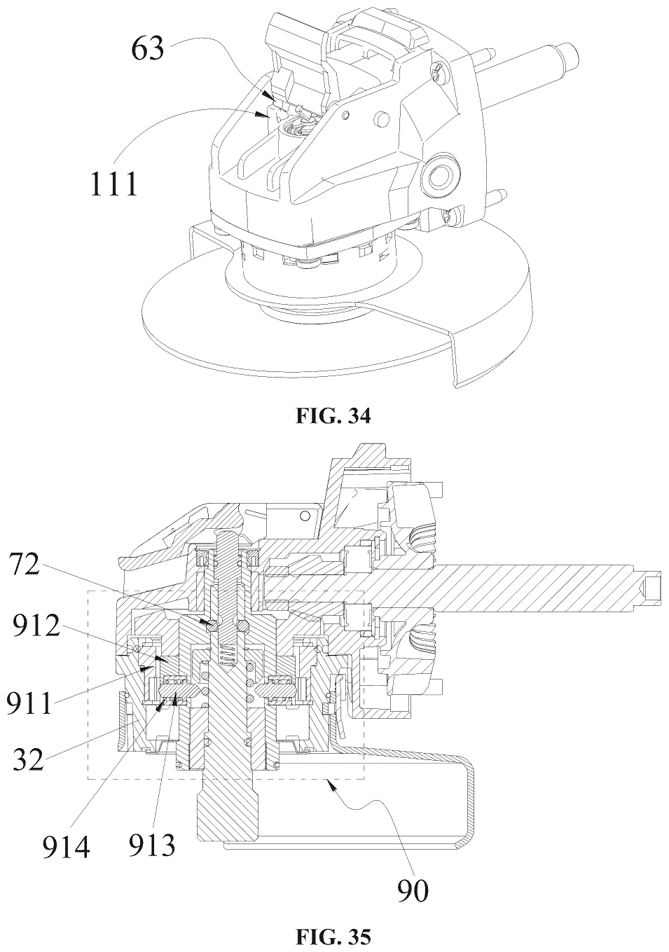

FIGS. 33 and 34 disclose a specific structure of the operating member 60. In this example, the operating member 60 includes a first contact portion 62 and a second contact portion 63. The first contact portion 62 is in contact with the topmost end of the top shaft 71 to drive the top shaft 71 to move. The head housing 11 includes a limiting protrusion 111 for limiting the movement position of the second contact portion 63 so that the operating member 60 can rotate no further than the third position and cannot reach a larger angle beyond the third position.

As shown in FIGS. 35 to 40, the present application further provides another technical solution for preventing the working attachment 100 from being mounted incorrectly.

Similar to the preceding example, the power tool 2 includes a transmission mechanism 40 that connects the motor shaft 21 to the output shaft 30. The electric motor 20 drives the motor shaft 21 to rotate, and the motor shaft 21 drives, through the transmission mechanism 40, the output shaft 30 to rotate about the first axis 301. The power tool includes a top shaft 71 that can be driven by the operating member 60 to move to drive the output shaft 30 to move. The power tool includes a gearbox 32 disposed on the outer circumference of the output shaft 30.

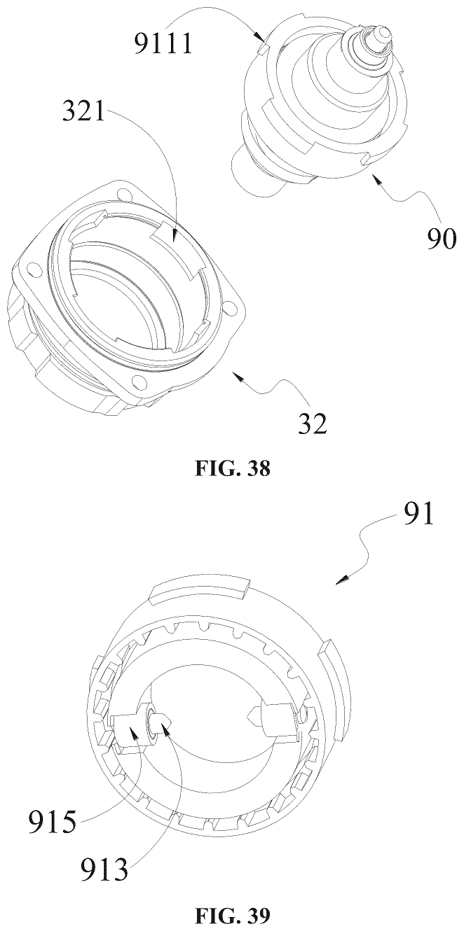

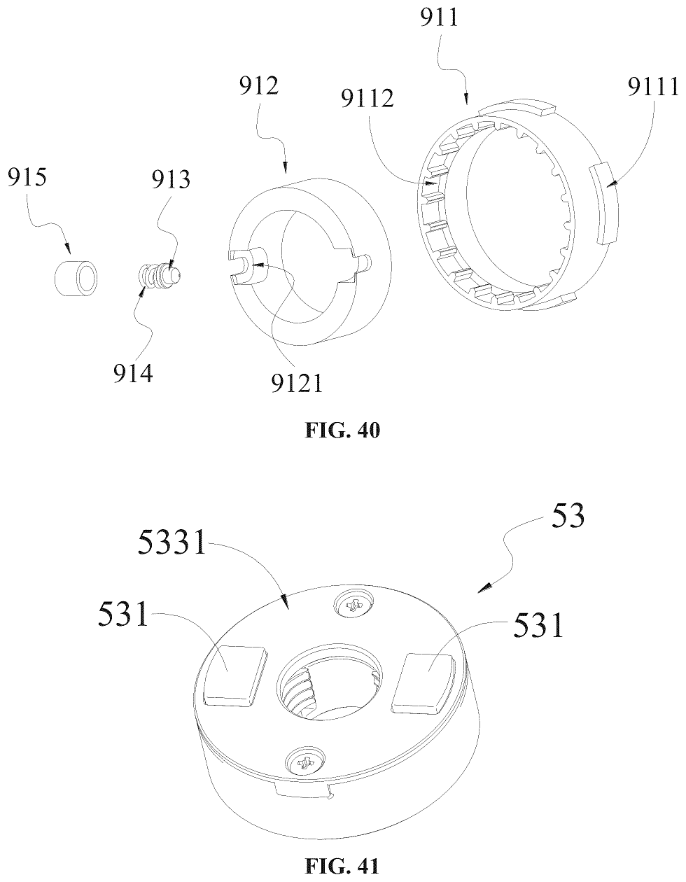

As shown in FIGS. 37 and 38, the anti-misinstallation mechanism 90 includes a ring gear assembly 91, the ring gear assembly 91 includes multiple protrusions 9111, multiple grooves 321 are formed on the gearbox 32, and each protrusion 9111 is in shape fit with each groove 321. As shown in FIGS. 39 and 40, the ring gear assembly 91 includes a gear sleeve 911 and a positioning ring 912, and the gear sleeve 911 is sleeved around the positioning ring 912. Locking teeth 9112 are disposed on the inner circumference of the gear sleeve 911. The positioning ring 912 is provided with two positioning grooves 9121. A positioning pin 913 is disposed in the positioning groove 9121. A collar 33 is sleeved on the output shaft 30, a retaining ring 331 is disposed on the output shaft 30 in a clamping manner, the retaining ring 331 drives the collar 33 to move along with the movement of the output shaft 30, and the collar 33 moves to drive the positioning pins 913 to extend into the locking teeth 9112.

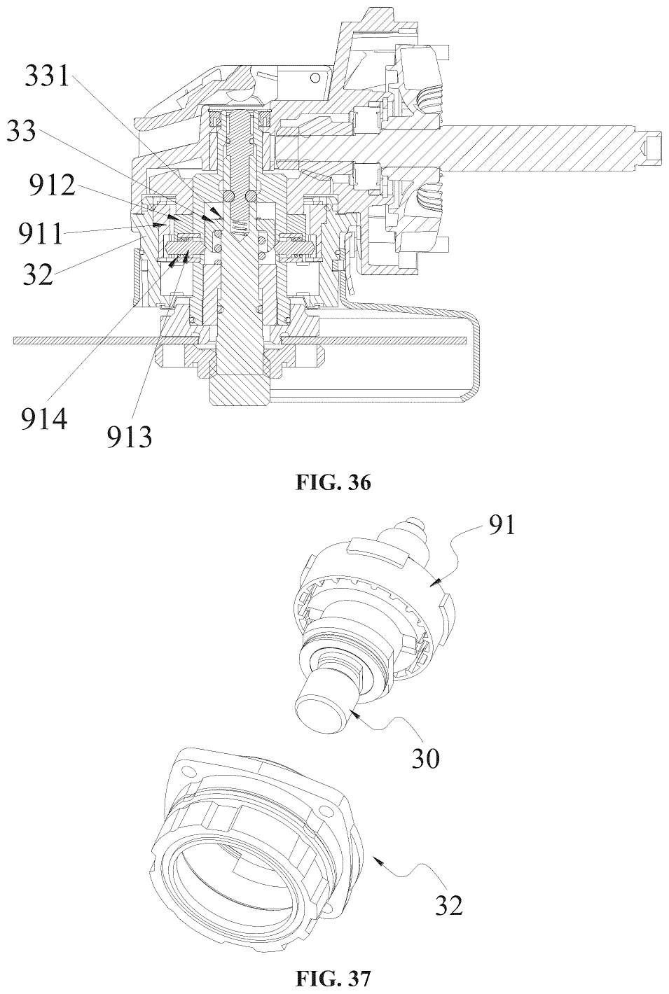

The ring gear assembly 91 has a first state and a second state. As shown in FIG. 35, in the first state, when the working attachment 100 is mounted in the mounted state and the operating member 60 is reset, the positioning pins 913 do not extend into the locking teeth 9112, and the ring gear assembly 91 allows the transmission mechanism 40 to rotate. As shown in FIG. 36, in the second state, when the working attachment 100 is mounted in the non-mounted state and the operating member 60 is reset, the positioning pins 913 extend into the locking teeth 9112, the locking teeth 9112 lock the gearbox 32, and at this time, the ring gear assembly 91 prevents the transmission mechanism 40 from rotating. The ring gear assembly 91 includes the locking teeth 9112 and the positioning pins 913. The top shaft 71 moves to drive the positioning pins 913 to extend into the locking teeth 9112 so that the transmission mechanism 40 cannot move.

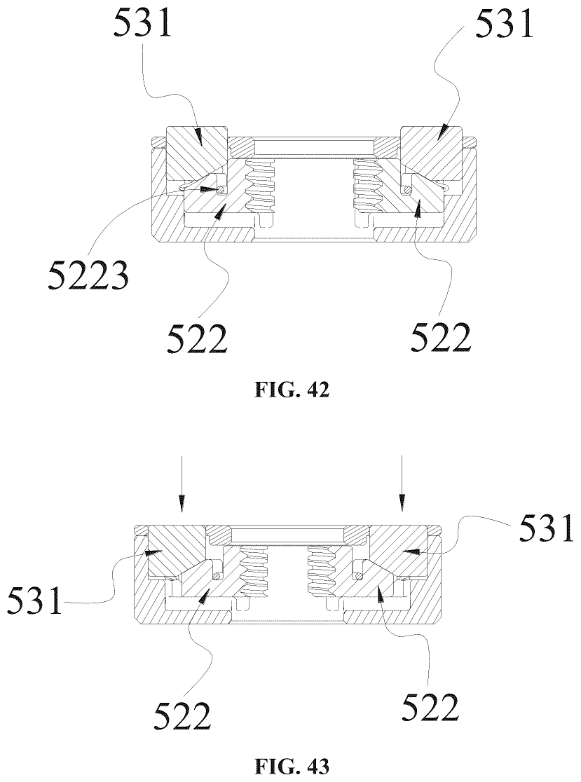

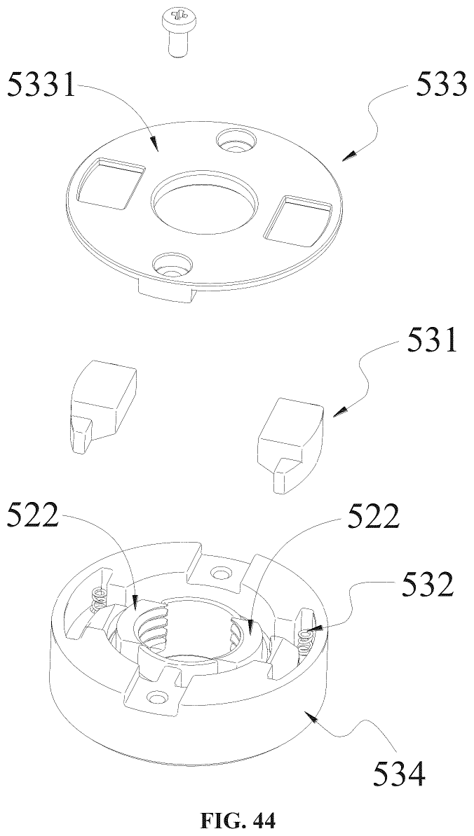

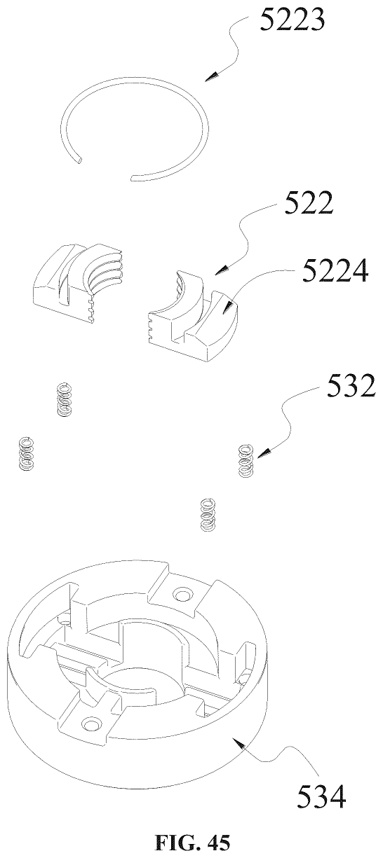

FIGS. 41 to 45 disclose an example of a quick release flange 53. The quick release flange 53 here can replace the lower flange 52 in the preceding examples, and the upper flange 51 and the quick release flange 53 can jointly lock the working attachment 100 on the output shaft 30.

The quick release flange 53 includes driving blocks 531, movable members 522, fourth elastic members 532, a body 534, and a top cover 533. The body 532 and the top cover 533 form an accommodation space for accommodating the movable members 522, the fourth elastic members 532, and part of the driving blocks 531. The top cover 533 has a top surface 5331 located on the upper surface of the top cover 533. When the quick release flange 53 and the working attachment 100 are correctly assembled, the top surface 5331 is in contact with the lower surface of the working attachment 100.

The fourth elastic members 532 are located in a mounting groove of the body 534 and provide thrust for resetting the driving blocks 531. The two movable members 522 are connected by an elastic ring 5223, and the elastic ring 5223 provides outward thrust for the movable members 522. The movable member 522 has a driving surface 5224, and the driving surfaces 5224 can be driven by the driving blocks 531 so that the distance between the two movable members 522 is reduced or increased. When the driving blocks 531 are pressed downward, the fourth elastic members 532 are compressed downward so that the distance between the two movable members 522 is reduced. When the top surface 5331 of the quick release flange 53 is separated from the lower surface of the working attachment 100, the driving blocks 531 are pushed out by the thrust of the fourth elastic members 532, and the distance between the two movable members 522 is increased.

The following describes the position where the anti-misinstallation mechanism 90 may be disposed on the power tool 2.

As shown in FIG. 2, the power tool 1 is defined to have a front portion 210, a middle portion 220, and a rear portion 230. The middle portion 220 is located between the front portion 210 and the rear portion 230. The middle portion 220 allows a smooth transition between the front portion 210 and the rear portion 230. The middle portion 220 is the grip 12 for the user to hold, the rear portion 230 is an energy connecting portion, and the front portion 210 is a portion in front of the grip 12, that is, a region extending from the gripping region for the user to hold to the end of the output shaft 30. The front portion 210 includes at least the transmission mechanism 40, and which region the electric motor 20 belongs to depends on the position of the electric motor 20. That is, the electric motor 20 may be partially located in the front portion 210 and partially located in the middle portion 220. If the power tool 2 is powered by a battery pack, the rear portion 230 is the battery pack coupling portion 13 connected to the battery pack. If the power tool 2 is powered by mains power, the rear portion 230 is a power supply portion connected to the mains power supply line.

For all the examples described above in the present application, the anti-misinstallation mechanism 90 may be disposed in the front portion 210 of the power tool 2 or in the middle portion 220 of the power tool. In an example, the anti-misinstallation mechanism 90 may be partially disposed in the front portion 210 and partially disposed in the middle portion 220. In an example, the anti-misinstallation mechanism 90 may be disposed inside the head housing 11. In an example, the anti-misinstallation mechanism 90 may be partially disposed in the head housing 11 and partially disposed in the middle portion 220.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A power tool, comprising:
a grip for a user to hold;
an output shaft rotatable about a first axis;
a mounting device for mounting a working attachment to the output shaft, the working attachment has a mounting port that matches the output shaft; and
an operating member capable of driving the output shaft to move along a direction of the first axis to lock or loosen the working attachment;
wherein the operating member could be located at least at a first position and a second position, when the operating member is located at the first position, the working attachment is locked; when the operating member moves from the first position to the second position, the output shaft moves downward along the first axis by a first preset distance; and the operating member can further be located at a third position, the third position is different from the first position and the second position.

2. The power tool of claim 1, wherein the mounting port is circular.

3. The power tool of claim 1, further comprising a locking member, wherein the locking member is capable of being driven by the operating member to move to drive the output shaft to move.

4. The power tool of claim 3, wherein the operating member is in shape fit or concave-convex fit with the locking member so that when the operating member rotates to a position to loosen the working attachment, the locking member does not rotate relative to the operating member.

5. The power tool of claim 1, further comprising a second elastic member always in a compressed state to apply an elastic force to the output shaft, wherein when the output shaft moves downward along the first axis, the output shaft further compresses the second elastic member.

6. The power tool of claim 5, wherein during a movable stroke of the operating member, a maximum pressure applied to the output shaft is greater than or equal to 80 N.

7. The power tool of claim 1, wherein the mounting device comprises an upper flange and a lower flange, the upper flange is closer to the operating member than the lower flange, the upper flange and the output shaft are movably connected, the lower flange and the output shaft are threadedly connected, and when the working attachment is mounted on the output shaft, the working attachment is mounted between the upper flange and the lower flange.

8. The power tool of claim 7, wherein the operating member is rotatable about a second axis, wherein the second axis is basically perpendicular to the first axis, or the second axis is basically parallel to the first axis.

9. The power tool of claim 8, wherein the lower flange comprises a flange body and movable members, a movable member of the movable members is provided with a mating portion mating with external threads of the output shaft, the movable member has a locked state in which the movable member is connected to the output shaft and an unlocked state in which the movable member is detached from the output shaft, the movable member switches to the locked state when the movable member abuts against the working attachment, and the movable member switches to the unlocked state when the movable member is detached from the working attachment.

10. The power tool of claim 9, wherein the movable member is mounted on the flange body via a rotary shaft, the movable member is rotatable about an axis of the rotary shaft, and the axis of the rotary shaft is perpendicular to the first axis.

11. The power tool of claim 9, wherein sliding grooves are obliquely disposed on the flange body, the movable member is movable along a sliding groove of the sliding grooves, and when the movable member moves in the sliding groove, the movable member is capable of being displaced along the direction of the first axis.

12. The power tool of claim 1, further comprising:
a locking member, wherein an upper end surface of the output shaft is provided with a countersunk hole, a portion of the locking member is disposed in the countersunk hole, the locking member mates with the operating member to drive the output shaft, and an outer wall of the locking member is provided with locking grooves;
locking beads, wherein a sidewall of the output shaft is provided with locking holes connecting with the countersunk hole, the locking beads are movably disposed in the locking holes, and the locking beads are capable of mating with the locking grooves to limit a movement distance of the output shaft; and
a first elastic member that is disposed in the countersunk hole, is in a compressed state, and is disposed between a lower end of the locking member and a bottom wall of the countersunk hole.

13. The power tool of claim 1, further comprising an anti-misinstallation mechanism, wherein the anti-misinstallation mechanism allows the output shaft to rotate after the working attachment in a mounted state is mounted to the output shaft; and the anti-misinstallation mechanism prevents the output shaft from rotating after the working attachment in a non-mounted state is mounted to the output shaft.

14. A power tool, comprising:
an output shaft rotatable about a first axis;
a mounting device for mounting a working attachment to the output shaft; and
an operating member capable of driving the output shaft to move along a direction of the first axis to lock or loosen the working attachment;
wherein the operating member can be located at three positions comprising a first position, a second position and a third position, when the operating member is located at the first position, the working attachment is locked; when the operating member is located at the second position, the working attachment is capable of being mounted to the output shaft; and when the operating member is located at the third position, the working attachment is capable of being removed from the output shaft.

15. The power tool of claim 14, wherein the working attachment has a mounting port that matches the output shaft, and the mounting port is circular.

16. The power tool of claim 14, further comprising an anti-misinstallation mechanism, wherein the anti-misinstallation mechanism allows the output shaft to rotate after the working attachment in a mounted state is mounted to the output shaft; and the anti-misinstallation mechanism prevents the output shaft from rotating after the working attachment in a non-mounted state is mounted to the output shaft.

17. A power tool, comprising:
an output shaft rotatable about a first axis;
a mounting device for mounting a working attachment to the output shaft; and
an operating member capable of driving the output shaft to move along a direction of the first axis to lock or loosen the working attachment;
wherein the operating member can be located at a first position, a second position, or a third position, when the operating member is located at the first position, the working attachment is locked; when the operating member moves from the first position to the second position, the output shaft moves downward along the first axis by a first preset distance; and when the operating member moves from the first position to the third position, the output shaft moves downward along the first axis by a second preset distance, wherein the second preset distance is greater than the first preset distance.

18. The power tool of claim 17, further comprising an anti-misinstallation mechanism, wherein the anti-misinstallation mechanism allows the output shaft to rotate after the working attachment in a mounted state is mounted to the output shaft; and the anti-misinstallation mechanism prevents the output shaft from rotating after the working attachment in a non-mounted state is mounted to the output shaft.
